(19) United States
(12) Patent Application Publication
(10) Pub. No.: US 2013/0047030 A1
(43) Pub. Date: Feb. 21, 2013

(54) STORAGE APPARATUS AND POWER SUPPLY METHOD

(71) Applicants: Tomonori Soeda, Oiso (JP); Hiroshi Suzuki, Sagamihara (JP); Fumiaki Hosaka, Odawara (JP); Toshimitsu Shishido, Kaisei (JP)

(72) Inventors: Tomonori Soeda, Oiso (JP); Hiroshi Suzuki, Sagamihara (JP); Fumiaki Hosaka, Odawara (JP); Toshimitsu Shishido, Kaisei (JP)

(73) Assignee: Hitachi, Ltd.

(21) Appl. No.: 13/203,907

(22) PCT Filed: Aug. 18, 2011
(86) PCT No.: PCT/JP11/04621

§ 371 Date: Aug. 30, 2011

(51) Int. Cl. G06F 1/26; G06F 11/07

(52) U.S. Cl. 714/14; 713/300; 714/E11.021

(57) ABSTRACT

The supply of power to a storage apparatus can be made redundant by means of power inputs from two types of power supply, namely an AC power supply and a DC power supply.

The storage apparatus comprises a power supply unit for supplying power to a plurality of storage devices, and a power supply controller for controlling a method of supplying power from the power supply unit, wherein the power supply unit makes redundant the power supplied from a first power supply device which supplies AC power and/or from a second power supply device which supplies DC power, and supplies this power to the plurality of storage devices, and wherein, in response to an operator configuration input, the power supply controller supplies power from the first power supply device to one storage device among the plurality of storage devices and supplies power from the second power supply device to another storage device.

### TECHNICAL FIELD

The present invention relates to a storage apparatus and a power supply method and is suitably applied to a storage apparatus to which power can be supplied from a DC power device and a power supply method.

### BACKGROUND ART

In recent years, in order to handle various large-volume data in various government, corporate and university institutions and other types of institutions, data has been managed using comparatively large-scale storage apparatuses. A large-scale storage apparatus of this kind is configured having a plurality of storage devices (hard disk drives and so on, for example) arranged in an array. For example, one RAID (Redundant Arrays of Independent Disks) group is configured from one or more hard disk drives, and one or more logical volumes are defined in a physical storage area provided by one RAID group. Furthermore, the logical volumes are provided to the host apparatus. The host apparatus is able to perform data writing and reading by transmitting predetermined commands to logical volumes.

Furthermore, the power supply of the storage apparatus is also made redundant for the sake of the high reliability and high availability of the storage apparatus. For example, in PTL1, the supply and disconnection of the power supply can be individually controlled for each storage device by making redundant the DC/DC converter which supplies DC power to a plurality of hard disk drives.

### CITATION LIST

### Patent Literature

[PTL1] Japanese Published Patent Application No. 2008-193876

[PTL2] Japanese Published Patent Application No. 2008-102804

### SUMMARY OF INVENTION

### Technical Problem

Furthermore, conventionally, the supply of power to a storage apparatus is typically made via an AC power supply input and conversion from the AC power supply to a DC power supply (AC/DC conversion) is performed in the storage apparatus. However, in recent years, there has been a trend toward the user using the storage apparatus furnishing same with a DC power supply device and a demand has arisen for a storage apparatus which is capable of receiving not only an AC power input but also a DC power input. It is also desirable, while enabling a DC power input, to make redundant the supply of power by supporting two power supply systems of two types, namely, an AC power supply system and a DC power supply system, in order to provide power supply redundancy.

The present invention was conceived in view of the above points and proposes a storage apparatus which enables power supply redundancy by means of a power supply input from two types of power supply, namely an AC power supply and a DC power supply, as well as a power supply method.

### Solution to Problem

In order to achieve the foregoing object, the present invention provides a storage apparatus, comprising a power supply unit for supplying power to a plurality of storage devices; and a power supply controller for controlling a method of supplying power from the power supply unit, wherein the power supply unit makes redundant the power supplied from a first power supply device which supplies AC power and/or from a second power supply device which supplies DC power, and supplies this power to the plurality of storage devices, and wherein, in response to a configuration input by the operator, the power supply controller supplies power from the first power supply device to one storage device among the plurality of storage devices and supplies power from the second power supply device to another storage device.

With this configuration, the power supply from the first power supply device for supplying AC power and the power supply from the second power supply device for supplying DC power can be made redundant and this power supplied to the storage apparatus and, in response to the configuration input by the operator, the power supply from the first power supply device can be supplied to any of the storage devices among the plurality of storage devices, while the power supply from the second power supply device can be supplied to any of these storage devices. As a result, power from two types of power supply, namely, an AC power supply and DC power supply, can be supplied to the storage apparatus with redundancy, whereby high reliability and high availability can be realized for the storage apparatus.

### Advantageous Effects of Invention

The present invention enables high reliability and high availability to be realized for a storage apparatus by making the supply of power to the storage apparatus redundant by means of a power supply input from two types of power supply, namely, an AC power supply and a DC power supply.

### BRIEF DESCRIPTION OF DRAWINGS

FIG. 1 is a conceptual view which provides an overview of an embodiment of the present invention.

FIG. 2 is a perspective view showing an external configuration of a storage apparatus according to this embodiment.

FIG. 3 is a perspective view showing an external configuration of the storage apparatus according to this embodiment.

FIG. 4 is a perspective view showing an external configuration of a disk controller module according to this embodiment.

FIG. 5 is a block diagram showing a configuration of a computer system according to this embodiment.

FIG. 6 is a block diagram showing a configuration of a computer system according to this embodiment.

FIG. 7 is a conceptual view of the power supply status during power failure according to this embodiment.

FIG. 8 is a conceptual view of the power supply status during power failure according to this embodiment.

FIG. 9 is a conceptual view of the power supply status during power failure according to this embodiment.

FIG. 10 is a conceptual view of the power supply status during power failure according to this embodiment.

FIG. 11 is a flowchart showing processing content of processing to configure the DC power source according to this embodiment.

FIG. 12 is a table showing content for configuring power specifications according to this embodiment.

FIG. 13A is a flowchart showing processing content of power distribution configuration processing according to this embodiment.

FIG. 13B is a flowchart showing processing content of power distribution configuration processing according to this embodiment.

FIG. 14 is a table showing configuration content of a power feed to each volume according to this embodiment.

FIG. 15 is a flowchart showing processing content for collection copy processing according to this embodiment.

FIG. 16 is a table showing content for configuring the supply of power during collection copy processing according to this embodiment.

FIG. 17 is a flowchart showing processing content of processing for calculating power consumption according to this embodiment.

FIG. 18 is a table showing the content of reference information during power consumption calculation processing according to this embodiment.

### DESCRIPTION OF EMBODIMENTS

An embodiment of the present invention will be described in detail hereinbelow.

(1) Summary of Embodiment

First, a summary of the embodiment will be provided. In recent years, in order to handle various large-volume data in various government, corporate and university institutions and other types of institutions, data has been managed using comparatively large-scale storage apparatuses. A large-scale storage apparatus of this kind is configured having a plurality of storage devices (hard disk drives and so on, for example) arranged in an array. For example, one RAID (Redundant Arrays of Independent Disks) group is configured from one or more hard disk drives, and one or more logical volumes are defined in a physical storage area provided by one RAID group. Furthermore, the logical volumes are provided to the host apparatus. The host apparatus is able to perform data writing and reading by transmitting predetermined commands to logical volumes.

Furthermore, the power supply device of the storage apparatus is also made redundant for the sake of the high reliability and high availability of the storage apparatus. For example, in PTL1, the supply and disconnection of the power supply can be individually controlled for each storage device by making redundant the DC/DC converter which supplies DC power to the plurality of hard disk drives.

Further, conventionally, the supply of power to the storage apparatus is typically made via an AC power supply input and conversion from an AC power supply to a DC power supply (AC/DC conversion) is performed in the storage apparatus. However, in recent years, there has been a trend toward the user using the storage apparatus furnishing same with a DC power device and a demand has arisen for a storage apparatus which is capable of receiving not only an AC power input but also a DC power input. It is also desirable, while enabling a DC power input, to make redundant the supply of power by supporting two power supply systems of two types, namely, an AC power supply system and a DC power supply system, in order to provide power supply redundancy.

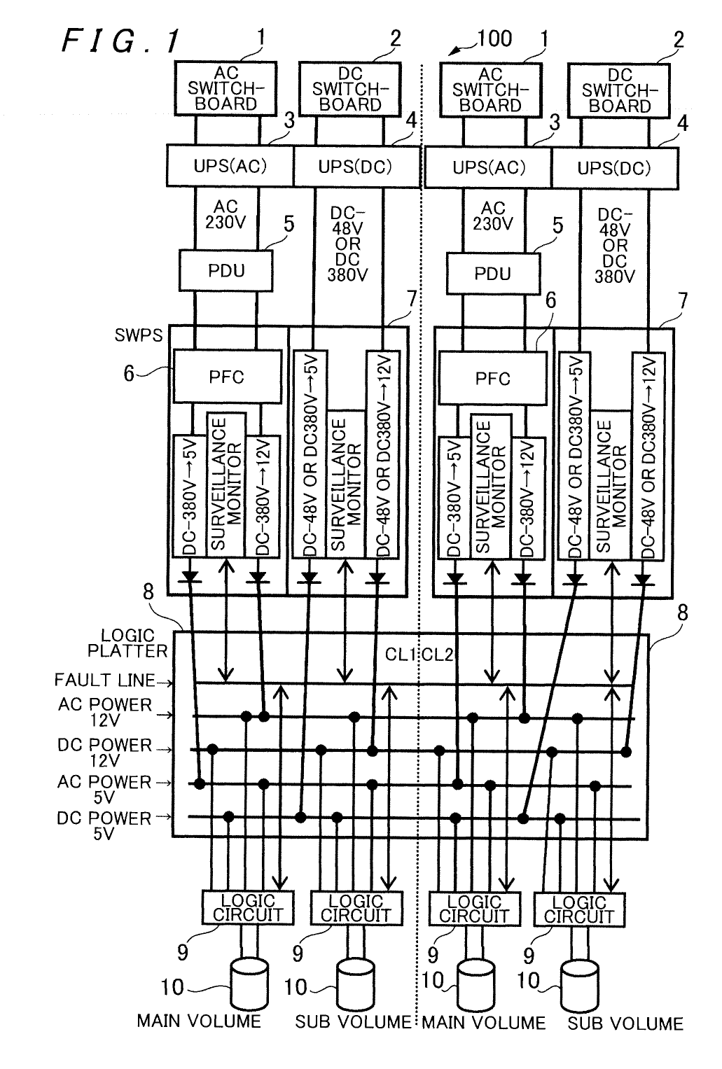

As shown in FIG. 1, a storage apparatus 100 according to this embodiment is configured so as to be capable of supporting an AC power supply system to which AC power is supplied from an AC switchboard 1 and a DC power supply system to which DC power is supplied from a DC switchboard 2. For example, if an AC power supply system capable of supplying AC power from the AC switchboard 1 is installed in the storage apparatus 100 as standard, power sources with different power specifications can be made redundant by introducing a DC power supply system, thus making it possible to improve the reliability of the storage apparatus 100.

Furthermore, although power is generally fed to the storage apparatus 100 from an uninterruptible power supply (hereinafter UPS) 3 with an AC power output, power efficiency can be enhanced by about 2 to 4% and thermal efficiency can be reduced by feeding power to the storage apparatus 100 from a UPS (DC) 4 with a DC power output. This is because, as shown in FIG. 1, if power is fed from the UPS (DC) 4 with a DC power output, a PFC (Power Factor Correction) module 6 is not required. The PFC module 6 is a module which enhances the power factor by reducing and extending the current waveform. Here, the power factor is a value which is defined relating to the efficiency of AC power and indicates the ratio between apparent power and effective power and expresses the phase difference discrepancy between voltage and current as a ratio. As mentioned earlier, utilizing PFC module 6 enhances the power factor and enables the generation of harmonics to be suppressed, and hence there is no need to use wires any thicker than required for the transmission wires and the peak current is small, which is advantageous in that it is hard for the breaker to fall. Therefore, by using the PFC module 6, there is a large amount of heat generated within the power supply, which has the disadvantage of weakening the thermal efficiency and raising manufacturing costs. Hence, when DC power is fed directly to the storage apparatus 100 from the DC switchboard 2, there is no need to provide a PFC module 6 in the switching power supply (SWPS) 7, thereby enhancing the power efficiency and reducing the thermal efficiency.

Furthermore, although power is typically fed, in an AC power supply system, to the storage apparatus 100 via a PDU power breaker (in the drawings PDU indicates a Power Distribution Unit) 5, in a DC power supply system in which DC power is fed directly to the storage apparatus 100 from a DC switchboard 2, DC power can be fed even when there is no PDU 5. The PDU 5 is a power outlet for distributing the power thus fed to each device in the storage apparatus. As shown in FIG. 1, by introducing DC power from the DC switchboard 2, there is no need to provide a PDU5 and the aforementioned PFC6, thus enabling the manufacturing costs of the apparatus to be reduced and lowering the device failure rate.

As shown in FIG. 1, a plurality of power lines are provided on a logic platter 8, thereby establishing redundancy for the supply of power to a storage medium 10 such as a hard disk drive. As a result, if a DC power supply system is configured as a supplementary power supply and a fault arises in an AC power supply system, switching from an AC power supply system to a DC power supply system can be performed simply in a logic circuit 9. Furthermore, if an anomaly arises in an AC power device and the abnormal mode of an AC power device is detected, the supply of power can be instantly switched from AC power to DC power, the passage of AC power can be stopped and the apparatus can be operated using auxiliary power of the DC power supply system. In addition, as a result of multiplexing the plurality of power lines provided on the logic platter 8 as mentioned earlier, the exchange work can be performed without halting the operation of the storage apparatus when the work to exchange the power supply is performed.

In addition, with this embodiment, an SVP (Service Processor) function can be used to collect various information such as configuration information and the power supply status in the storage apparatus 100, and the configuration information and the like in the storage apparatus 100 can be changed according to inputs by the system administrator. By using the SVP function, the supply of power to each device in the storage apparatus 100 can be freely configured.

The present invention was conceived in view of the above points and hence the high reliability and high availability of the storage apparatus can be realized by establishing power supply redundancy by means of a power supply input from two types of power supply, namely, an AC power supply and a DC power supply.

(2) External Configuration of the Storage Apparatus

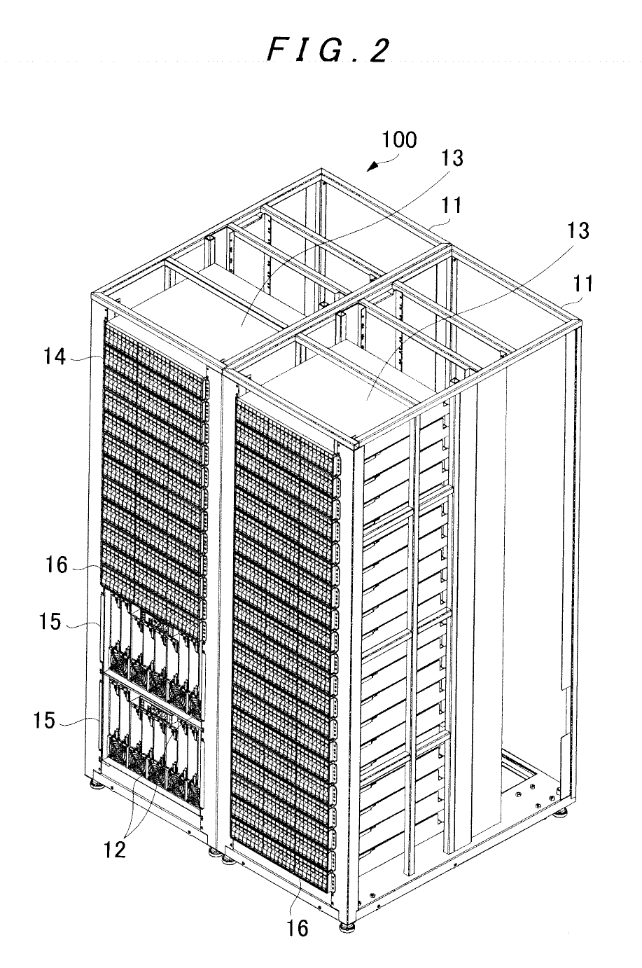

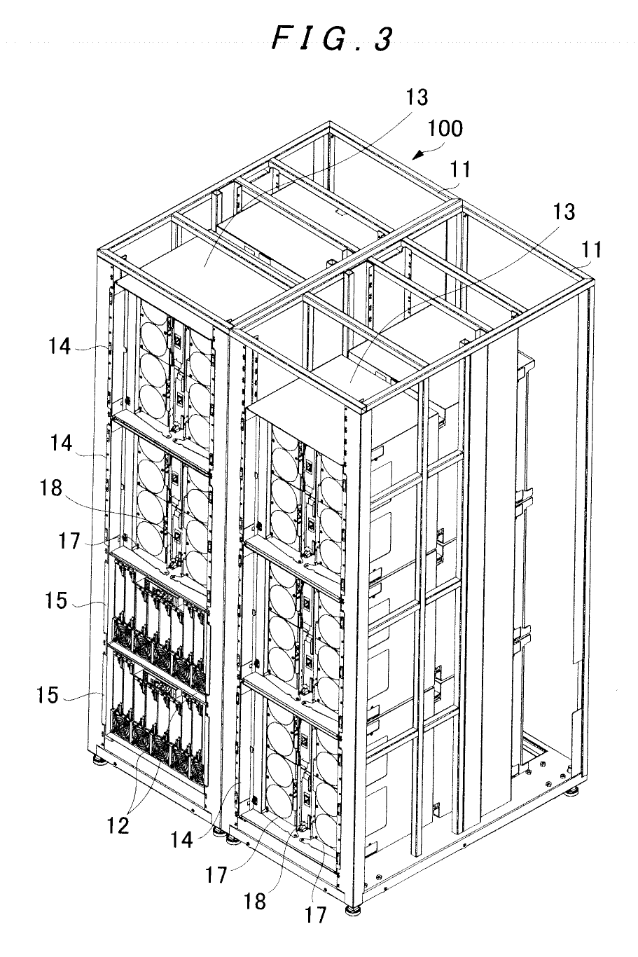

The external configuration of the storage apparatus will first be described with reference to FIGS. 2 to 4. The storage apparatus 100 is configured comprising an enclosure 11, a controller 12, and a driver device 13 as shown in FIGS. 2 and 3.

As shown in FIGS. 2 and 3, the controller 12 is configured by housing, in the enclosure 11, a disk controller (DKC) module 15, a disk unit (DKU: Disk Unit) module 14, a fan 17, and an AC/DC switching power supply 18, or the like, in an enclosure 11.

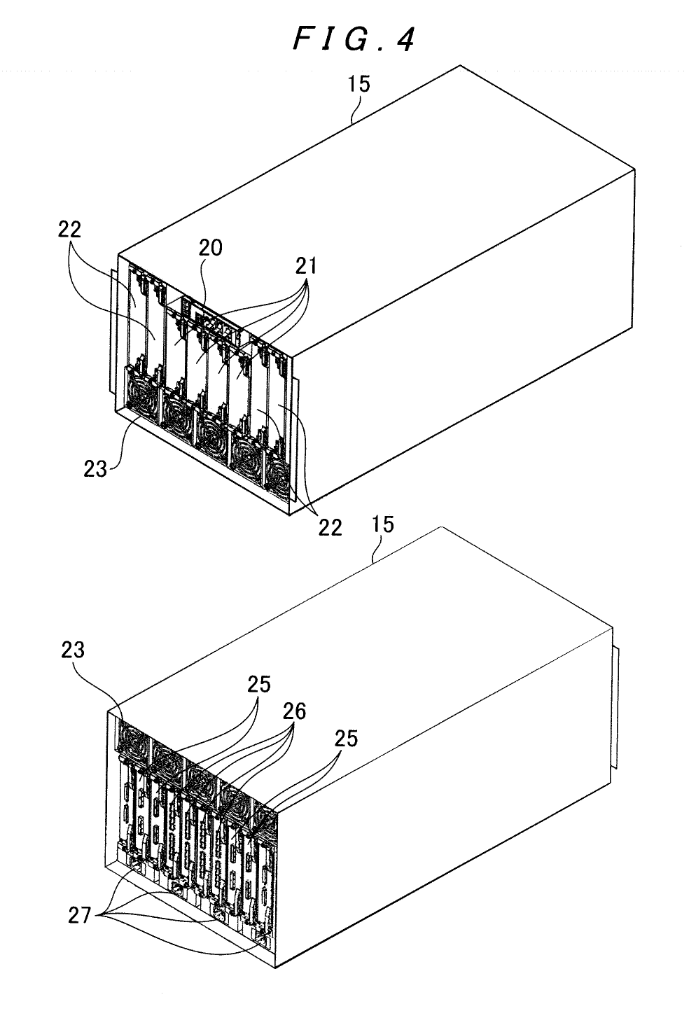

Logic substrates are detachably housed in a row in the disk controller module 15. The logic substrates are control boards for exercising control relating to data I/O processing to and from the disk drives, and various control of the storage apparatus 100 is performed by means of the logic substrates. As shown in FIG. 4, the logic substrates include, for example, a channel adapter (CHA) 26 for performing communication for data I/Os to and from an information processing device (hereinafter this apparatus is called the host apparatus) which uses the storage apparatus 100 as a storage device, a disk adapter (DKA) 25 which inputs and outputs data that is stored in the disk drive 16, and a cache memory 22 for temporarily storing data which is exchanged with the host apparatus, and the like.

The disk unit modules 14 are detachably housed in the enclosure 11 and house disk drives 16 for storing data. The disk drives 16 are devices for storing data which contain storage media. Hard disk drives, semiconductor storage devices, or the like, for example, can be adopted as the disk drives 16.

The fan 17 or fan 23 discharges air within the storage apparatus 100 to the outside and the heat generated by the disk controller module 15 or disk unit module 14 is expelled outside the controller 12 and the driver device 13.

In addition, an AC/DC switching power supply 18 is housed at the bottom of the disk unit module 14. Furthermore, an AC/DC switching power supply 22 is housed at the bottom of the disk controller module 15. If AC power is input, the AC/DC switching power supplies 18, 27 convert the AC power to DC power, and supply the DC power to the disk controller module 15 and disk drive 16. The disk controller module 15 and disk drive 16 operate under DC power with different voltages, but DC power with a voltage of 12V or 5V, for example, is supplied to the disk controller module 15 and disk drive 16 from the AC/DC switching power supplies 18, 27. Furthermore, the disk controller module 15 and disk drive 16 which receive the supply of power at these voltages perform the conversion to these respective voltages by means of a power conversion device (DC/DC converter) which the disk controller module 15 and disk drive 16 each comprise. In addition, if DC power is input, the AC/DC switching power supplies 18, 27 perform conversion to DC power with a 12V or 5V voltage, for example, and supply DC power to the disk controller module 15 and disk drive 16.

Furthermore, as shown in FIG. 4, the disk controller module 15 provides an operating panel 20 for receiving operating inputs by an operator who maintains and manages the storage apparatus 100.

Meanwhile, as shown in FIGS. 2 and 3, the driver device 13 is configured by housing, in the enclosure 11, the disk unit module 14, the fan 17, and the AC/DC switching power supply 18 and the like. The modules and the like are each the same as those used by the controller 12 and therefore a detailed description thereof will be omitted here. In the storage apparatus 100 according to this embodiment, the controller 12 and driver device 13 are both configured using a common enclosure 11. Furthermore, the driver device 13 is configured by housing the disk unit module 14 in the bottom section of the enclosure 11 in which the disk controller module 15 is housed in the controller 12.

Furthermore, as shown in FIG. 3, the fan 17 draws the air inside the disk unit module 14 housed in the driver device 13 and expels the air outside the driver device 13. As a result, heat which is generated by the disk drives 16 housed in the disk unit module 14 can be discharged to the outside of the driver device 13.

(3) Hardware Configuration of the Computer System

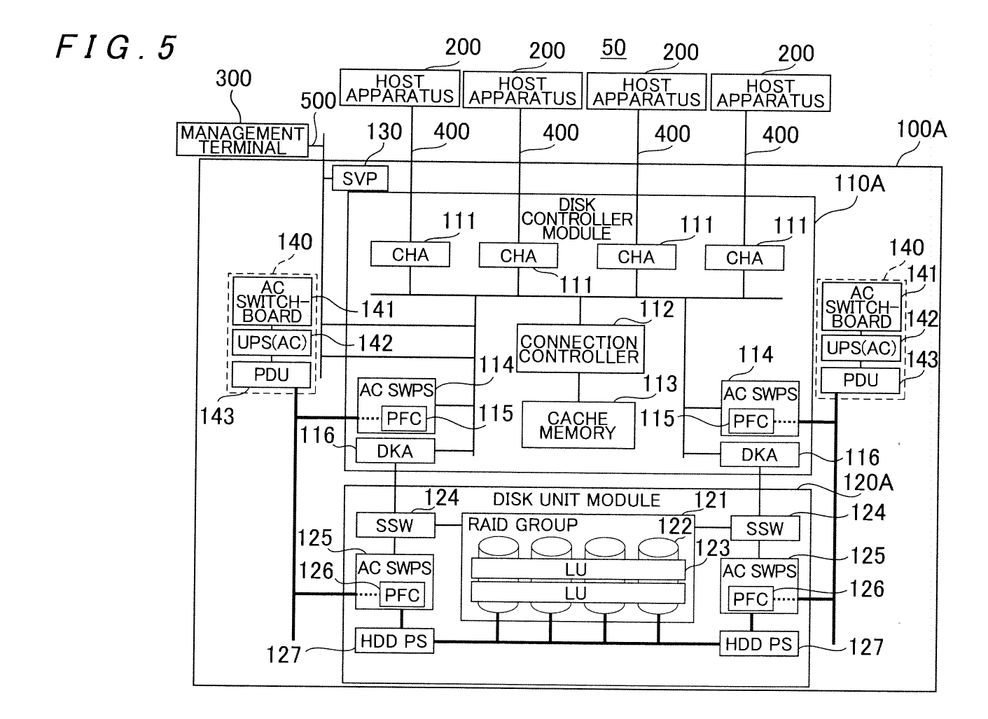

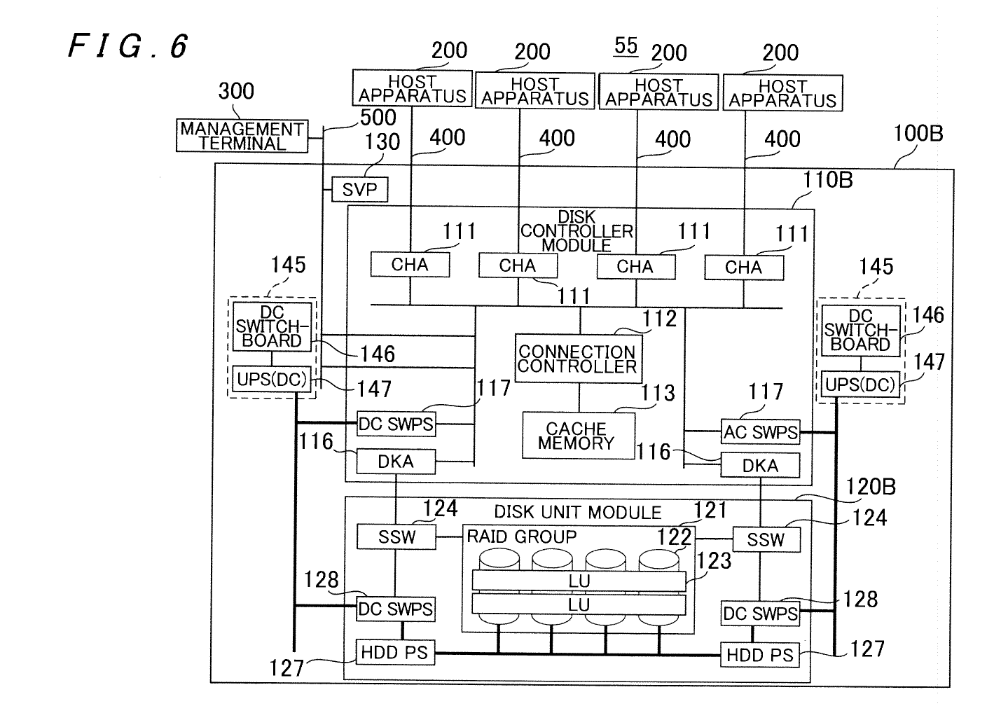

FIGS. 5 and 6 shows the configuration of the computer system which is configured comprising a storage apparatus which has the same external configuration as the storage apparatus 100. The computer system 50 shown in FIG. 5 is configured comprising a storage apparatus 100A which supports an AC power supply system. Furthermore, the computer system 55 shown in FIG. 6 is configured comprising a storage apparatus 100B which supports a DC power supply system.

As shown in FIG. 5, the computer system 50 is configured comprising the storage apparatus 100A, host apparatuses 200, and a management terminal 300.

The storage apparatus 100A has a plurality of host apparatuses 200 connected thereto via a network 400 and has a management terminal 300 connected thereto via a network 500.

The host apparatus 200 is a computer device comprising information processing resources such as a CPU (Central Processing Unit) and memory, and is configured from a personal computer, a workstation, or a mainframe, for example. The CPU functions as an arithmetic processing device and controls the operation of the host apparatuses 200 according to programs and arithmetic parameters and the like which are stored in the memory. In addition, the host apparatus 200 comprises information input devices such as a keyboard, switch, pointing device, and microphone, and information output devices such as a monitor display and speaker.

Furthermore, the host apparatus 200 is connected to the storage apparatus 100 via a network (not shown). The network is configured from a SAN (Storage Area Network), for example, and communications between devices are performed according to the Fibre Channel Protocol, for example. In addition, the network may be a LAN (Local Area Network), the Internet, a public line, or a dedicated line, or the like, for example. If the network is a LAN, communications between the devices are carried out according to the TCP/IP (Transmission Control Protocol/Internet Protocol) protocol, for example.

In addition, the host apparatus 200 is an apparatus which performs predetermined work processing by running software such as a database management system. Some or all of the data used in the work processing executed by the host apparatus 200 is stored in the storage apparatus 100A. The host apparatus 200 refers to the data stored in the storage apparatus 100A and transmits a read request or write request to the storage apparatus 100A via the network in order to update this data. The read request transmitted by the host apparatus 200 contains a LUN (Logical Unit Number) and LBA (Logical Block Address) which are managed by read target data, for example. In addition, a write request transmitted by the host apparatus 200 contains a LUN and LBA for writing write-target data as well as the write-target data, for example.

The management terminal 300 is a computer device comprising a CPU, memory, and I/O unit, and the like and is, for example, configured by a personal computer, workstation, or mainframe, or the like. In addition, the management terminal 300 is connected to the storage apparatus 100A via a network (not shown).

In addition, a CPU functions as an arithmetic processing device and controls the operation of the management terminal 300 according to the programs and arithmetic parameters and so on stored in the memory. In specific terms, the CPU reads a management program stored in the memory and implements management of the storage apparatus 100A by executing the management program.

The I/O unit is configured from information input devices such as a keyboard, a switch, pointing device, and microphone, and information output devices such as a monitor display and speaker, and the like, and receives input operations from the operator or the like and displays operating information of the storage apparatus 100A on a display device.

The storage apparatus 100A is mainly configured from a disk controller module 110A, a disk unit module 120A, an SVP 130, and a power supply unit 140.

The disk controller module 110A has the same external configuration as the aforementioned disk controller module 15, and comprises a plurality of channel adapters (abbreviated to CHA) 111, a connection controller 112, a cache memory 113, a plurality of AC switching power supplies (abbreviated to AC SWPS in the drawings) 114, and a plurality of disk adapters (abbreviated to DKA in the drawings) 116.

The channel adapters 111 have a function for controlling data transfer with the host apparatuses 200 and comprise a plurality of communication ports. The storage apparatus 100A may comprise a plurality of channel adapters 111; FIG. 5 includes four channel adapters, for example. The channel adapters 111 are prepared depending on the types of host apparatuses 200, and may be for use with open servers or mainframes, for example. The channel adapters 111 are each configured as a microcomputer system which comprises a microprocessor (MP) 21 and memory and parse and execute various commands which are received from the host apparatus 200. For example, the channel adapters 111 are each assigned a network address (an IP (Internet Protocol) address and WWN (World Wide Name), for example) for identifying the channel adapters 111 and, in this case, the channel adapters 111 can each be handled individually as NAS (Network Attached Storage). The channel adapters 111 are able to operate by means of a control program which is read and operated by the microprocessor.

The disk adapter 116 controls data communications with disk drives 122. The storage apparatus 100A may comprise a plurality of disk adapters 116 and, in FIG. 5, comprises two disk adapters 116, for example. The disk adapters 116 and the disk drives 122 are connected via a communication network such as a SAN, for example, and perform block unit data transfers according to the Fibre Channel Protocol. The disk adapters 116 monitor the states of the disk drives 122 as necessary and the monitoring result is transmitted to the SVP 130 via an internal network of the storage apparatus 100A.

Note that the channel adapters 111 and the disk adapters 116 may also each be configured as individual control circuit substrates, and a single control circuit substrate may comprise a channel adapter function and a disk adapter function.

The channel memory 113 is a storage medium which temporarily stores data received from the host apparatuses 200 and data and the like which is read from the disk drives 122. Furthermore, a portion of the cache memory 113 may be used as a control area for storing various control information, while the remainder may be used as a cache area for storing data.

The AC switching power supply 114 comprises a function for converting the AC power input by the power supply unit 140 to DC power and supplying the DC power to each of the parts of the disk controller module 110A. The AC switching power supply 114 is configured comprising a PFC 115. The PFC 115 is a module which improves the power factor by reducing and extending the current waveform as mentioned earlier, and which is required when converting AC power to DC power. The AC switching power supply 114 also comprises a DC to DC converter (not shown) and converts the DC voltage output by the PFC 115 to a predetermined voltage before outputting same.

The connection controller 112 connects each of the channel adapters 111, disk adapters 116, and cache memory 113. As a result, all of the channel adapters 111 and disk adapters 116 are able to access the cache memory 113. The connection controller 112 is configured from a crossbar switch or the like, for example.

The disk unit module 120A has the same external configuration as the aforementioned disk unit module 14 and comprises a RAID group 121 provided by a plurality of disk drives 122, as well as a plurality of switches 124 (abbreviated to SSW in the drawings), a plurality of AC switching power supplies 125 and a hard disk power supply controller (abbreviated to HDD PS in the drawings) 127.

As shown in FIG. 5, one or more logical volume volumes (abbreviated to LU in the drawings) 123 are configured in the storage area provided by the plurality of disk drives 122. In addition, the storage areas provided by the disk drives 122 may also be managed as a pool that is provided to the host apparatus 200. In this embodiment, a pool is provided by the RAID group 121. For example, a single RAID group is configured from a plurality of disk drives 122, and one or more logical volumes 123 are defined in the storage area provided by the single RAID group. Furthermore, the logical volumes provided by a plurality of RAID groups are managed as a single pool.

Hard disks, flexible disks, magnetic disks, semiconductor memory or optical disks or other such devices may be used for the disk drives 122.

The switch 124 connects each of the disk adapters 116 and disk drives 122. As a result, all of the disk adapters 116 are able to access the disk drive 122.

The AC switching power supply 125 comprises a function for converting the AC power input by the power supply unit 140 to DC power and supplying the DC power to each of the parts of the disk unit module 120A. The AC switching power supply 125 is configured comprising the PFC 126. As mentioned earlier, the PFC 126 is a module which improves the power factor by reducing and extending the current waveform as mentioned earlier, and which is required when converting AC power to DC power.

The hard disk power supply controller 127 has a function for controlling the supply of power to the disk drives 122 such as hard disks.

The SVP 130 is connected to each of the parts of the disk controller module 110A and each of the parts of the disk unit module 120A via a network such as a LAN. The SVP 130 is also connected to the management terminal 300 and comprises a function for collecting various information in the storage apparatus 100A and providing the information to the management terminal 300. The SVP 130 also changes the configuration or the like of the storage apparatus 100A in response to an instruction from the system administrator or the like which is input via the management terminal 300. In addition, the SVP 130 is able to collect not only various information in the storage apparatus 100A but also various information in other storage apparatuses such as the storage apparatus 100A which supports a DC power supply system, described subsequently, for example, and is able to configure and change the various information of the storage apparatuses.

The power supply unit 140 is configured from an AC switchboard 141, a UPS (AC) (AC uninterruptible power supply device) 142, and a PDU power supply breaker (abbreviated to PDU in the drawings) 143, and the like. The AC switchboard 141 is a device for distributing AC power and supplies AC power to the UPS (AC) 142. The UPS (AC) 142 is a device which comprises a battery and functions as a backup power supply when the voltage drops or at the time of a power outage. The UPS (AC) 142 performs AC to DC conversion for the AC power supply which is input from the AC switchboard 141, stores power in the battery, performs DC to AC conversion, and then outputs AC power. The PDU power breaker 143 is a power outlet for distributing the power supplied from the UPS (AC) 142 to each of the parts in the disk controller module 110A and the disk unit module 120A.

As shown in FIG. 6, the computer system 55 is configured comprising a storage apparatus 100B which supports the DC power supply system, as well as host apparatuses 200 and a management terminal 300.

The configuration which differs from that of the computer system 50 shown in FIG. 5 will be described in detail hereinbelow, and a detailed description of the same configuration will be omitted.

The storage apparatus 100B is mainly configured from a disk controller module 110B, a disk unit module 120B, an SVP 130, and a power supply unit 145.

The disk controller module 110B differs from the disk controller module 110A shown in FIG. 5 in comprising a DC switching power supply (abbreviated to DC SWPS in the drawings) 117 in place of the AC switching power supply 114.

The DC switching power supply 117 comprises a function for supplying DC power input from the power supply unit 145 to each of the parts of the disk controller module 110B. In addition, the DC switching power supply 117 comprises a DC to DC converter (not shown) and converts the DC voltage input to the DC switching power supply 117 to a predetermined voltage.

The disk unit module 120B differs from the disk unit module 120A shown in FIG. 5 in comprising a DC switching power supply (abbreviated to DC SWPS in the drawings) 128 instead of the AC switching power supply 125. The DC switching power supply 128 has the same function as the foregoing DC switching power supply 117 and hence a detailed description is omitted.

The power supply unit 125 is configured from a DC switchboard 146 and a UPS (DC (DC uninterruptible power supply device) 147 or the like. The DC switchboard 146 is a device for distributing DC power and which supplies DC power to the UPS (DC) 147. The UPS (DC) 147 is a device which comprises a battery and which functions as a backup power supply at the time of a voltage drop or power outage. The UPS (DC) 147 stores the DC power supply which is input from the DC switchboard 146 in the battery and supplies the DC power which is stored in the battery to the DC switching power supply 117 or 128. The DC switching power supplies 117, 128 do not require the PFC 115 or 126 provided in the AC switching power supplies 114, 125 and hence the size of the DC switching power supplies 117, 128 can be reduced. Furthermore, by providing an external unit structure to the DC switching power supplies 117, 128 of a reduced size and making same the same size as the AC switching supplies 114, 117, compatibility can be maintained when a power supply is installed in the disk controller module 15 and disk unit module 14.

Thus, the storage apparatus 100B which supports a DC power supply system is able to supply DC power directly to the storage apparatus 100B from the DC switchboard 146 and hence the PFC 115 which is required by the storage apparatus 100A supporting the AC power supply system is no longer necessary. As a result, the heat generation within the power supply as a result of utilizing the PFC module can be avoided, and the thermal efficiency can be improved. In addition, not only is the PFC 115 not needed by the storage apparatus 100B, but also the PDU 143 which distributes power to each part is not required, thereby permitting a reduction in device manufacturing costs, a reduction in the apparatus failure rate, and a compatible structure.

(4) Power Supply Status When Power Fault Occurs

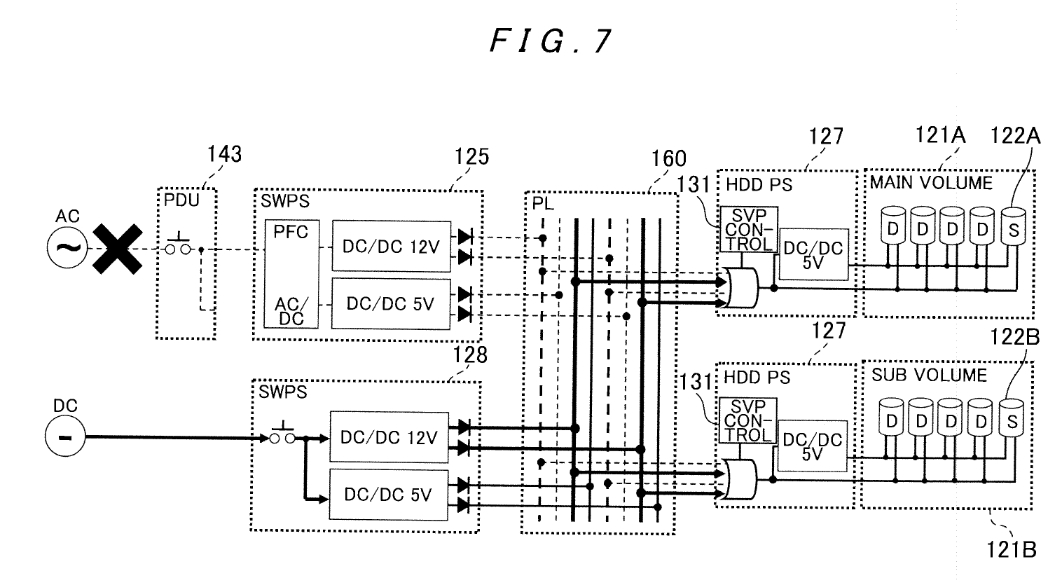

The power supply status when a power fault occurs in a case where redundancy is established for the supply of power by means of a power input from two types of power supply, namely, an AC power supply and a DC power supply, will be described next with reference to FIGS. 7 to 10. FIGS. 7 to 10 are block diagrams illustrating the foregoing computer system 50 or computer system 55.

FIG. 7 shows a state where a fault occurs with the AC switchboard 141 supplying power to the disk unit module 120A of the storage apparatus 100A supporting the AC power supply system and it is not possible to supply power to the disk unit module 120A. For example, in a case where a fault occurs with the AC switchboard 141 and power cannot be supplied from an AC power distribution device as in FIG. 7, the system is operated by supplying power from the DC switchboard 146 which is a DC power distribution device.

In FIG. 7, multiplexed power lines which extend from the AC switching power supply (SWPS) 125 and the DC switching power supply (SWPS) 128 are provided on a logic platter 160. As a result of this logic platter 160, if a fault occurs with the AC switchboard 141, power which is fed from the DC switchboard 146 is introduced to the hard disk power supply controller 127 and, under the control of the SVP 130, the supply of power is switched logically (OR circuit) and power is supplied to a main volume 122A and the subvolume 122B.

In addition, by pre-configuring configuration information relating to the supply of power from the SVP 130, the supply of power to the hard disk power supply controller 127 can be freely logically reconfigured (OR circuit). For example, the source of power can be distributed by changing the power supply system for each volume i.e. the power from the AC switchboard 141 can be supplied to the main volume 122A and the power from the DC switchboard 146 can be supplied to the subvolume 121B, or similar. The configuration information control processing by the SVP 130 will be described in detail subsequently.

Note that if power is supplied to the main volume 122A and subvolume 122B due to the configuration shown in FIG. 7, the main volume 122A or subvolume 122B must be configured as RAID1 only if there is no power supply redundancy for the sake of data protection, and in comparison with a case where power is supplied only by an AC power distribution device, the power consumption of the whole system can be reduced.

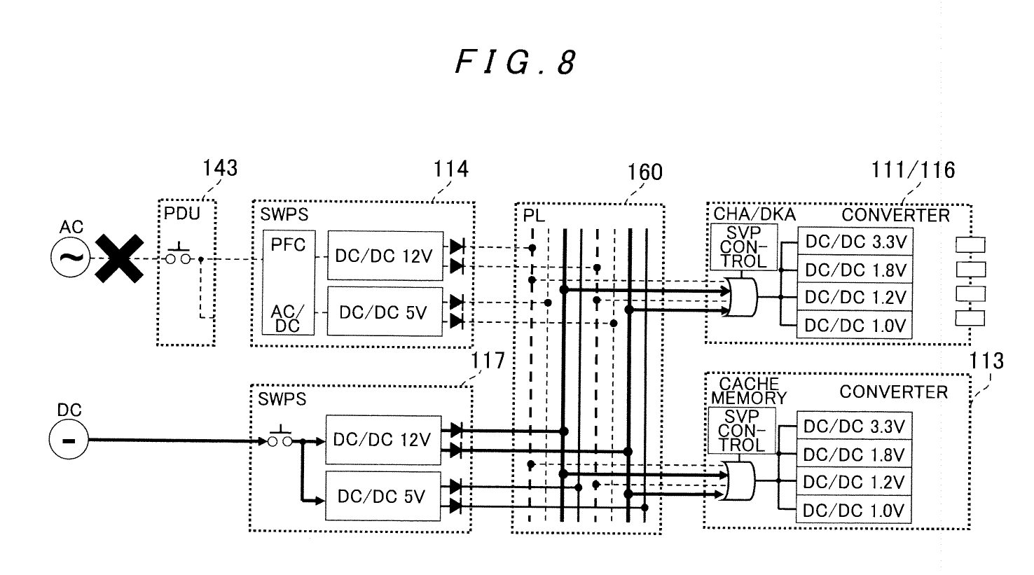

FIG. 8 shows a state where a fault occurs with the AC switchboard 141 for supplying power to the disk controller module 110A of the storage apparatus 100A supporting the AC power supply system and where power cannot be supplied to the disk controller module 110A. For example, in a case where a fault occurs with the AC switchboard 141 and power cannot be supplied from an AC power distribution device as in FIG. 8, the system is operated by supplying power from the DC switchboard 146 which is a DC power distribution device.

In FIG. 8, multiplexed power lines which extend from the AC switching power supply (SWPS) 115 and the DC switching power supply (SWPS) 117 are provided on the logic platter 160. As a result of this logic platter 160, if a fault occurs with the AC switchboard 141, power which is fed from the DC switchboard 146 is introduced to each of the parts such as the CHA 111, DKA 116, and the cache memory 113 of the disk controller module 110A and, under the control of the SVP 130, the supply of power is switched logically (OR circuit) and power is supplied to each of the volumes of the disk unit module 110B connected to the disk controller module 110A.

Furthermore, by pre-configuring configuration information relating to the supply of power from the SVP 130, the supply of power to the each of the parts of the disk controller module 110A can be freely logically (OR circuit) reconfigured based on the configuration information. In addition, by supplying power not only from the AC switchboard 141 but also from the DC switchboard 146, the power consumption can be reduced.

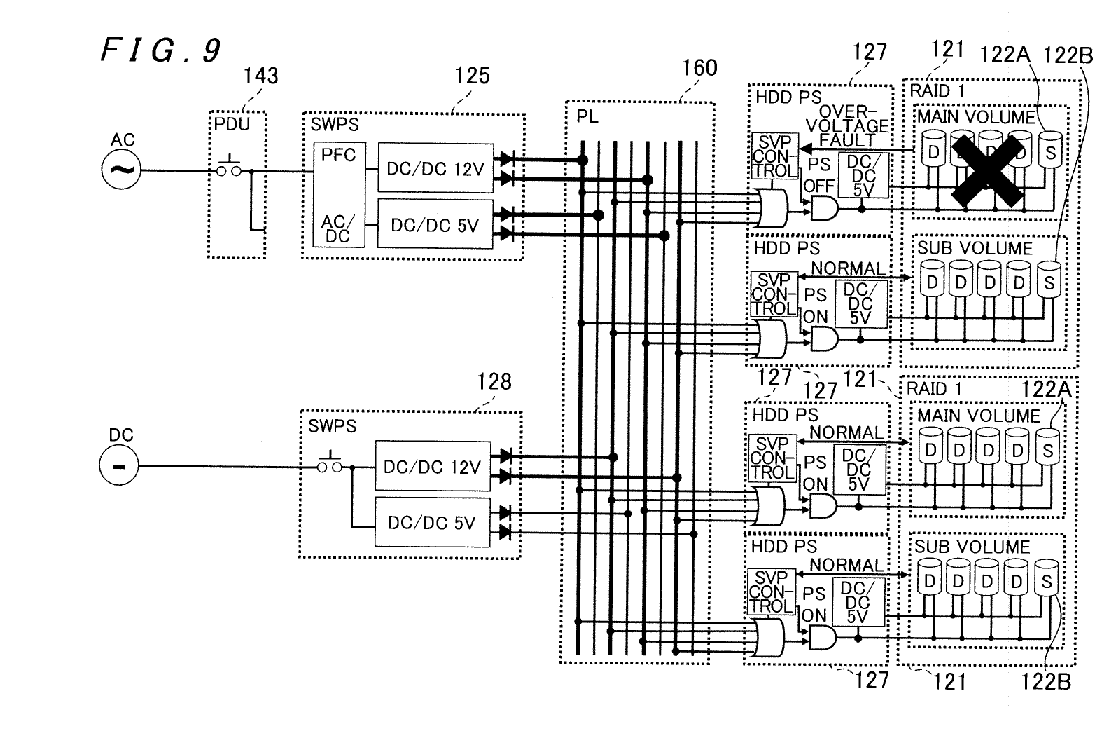

FIG. 9 shows a case where a power supply fault occurs when a disk drive 122 fails, when a hard disk fails, for example. Typically, the arrangement is such that, even when a hard disk fault occurs in the storage apparatus 100, a fault with the supply of power is not generated. However, unexpected faults may also arise. For example, a case where an overvoltage fault arises in the main volume 122A will be described.

If there is a hard disk problem or a short due to hard disk platter connector damage, an overvoltage is generated in the main volume 122A. If an overvoltage fault occurs in the main volume 122A, the fault is reported to the SVP 130 and the power is forcibly cut only to the volume in which the fault occurs as a result of the logic circuit (AND circuit) in the hard disk power supply controller 127. By forcibly cutting the power in this way, the power consumption of the storage apparatus 100 can be reduced and the part of the power supply where the overvoltage fault occurs can be prevented from catching fire. Furthermore, in cases where the main volume 122A and the subvolume 122B are configured as RAID1, for example, the writing of data to the subvolume 122 can be performed without halting the I/O requests from the host apparatus 200 and the operation of the whole system can be continued.

A case where a fault is generated on shared power wiring from the AC switching power supply 114 to the disk drive 122, that is, where a fault is generated on a logic platter 160 will be described next. For example, in a case where an AC power supply system is provided in duplicate and the supply of power from the AC switching power supply 114 to the disk drive 12 is duplexed, the system does not shut down even when failure occurs at one point in the wiring on the logic platter 160. However, the system does shut down if failure in the wiring on the logic platter 160 should occur at not one but two points on the power feed path to the disk drive 122.

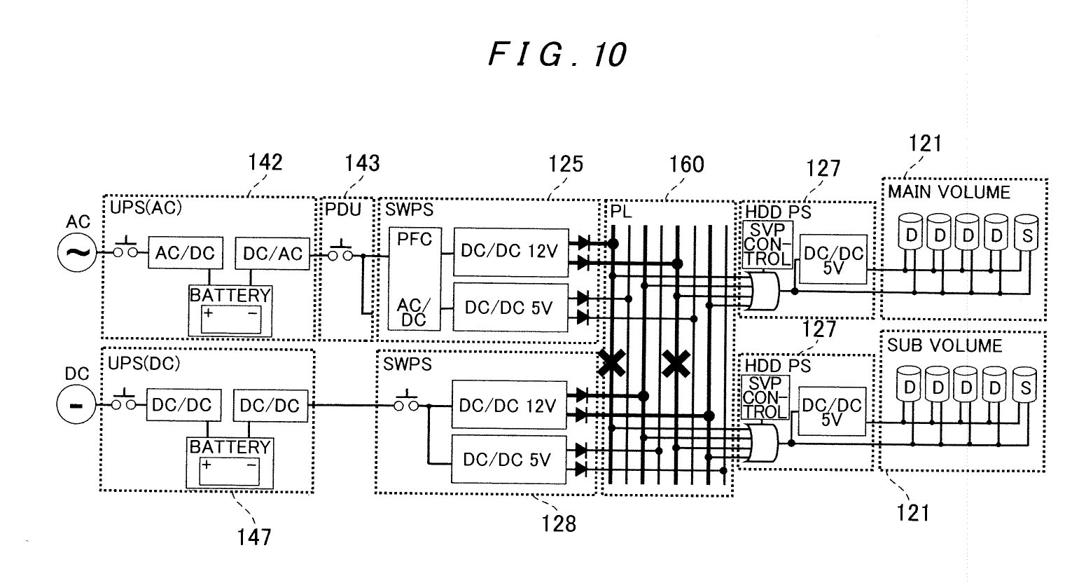

Therefore, in this embodiment, by providing redundancy for a plurality of wiring of the logic platter 160, a system shutdown due to failure at two points in the wiring can be avoided. As shown in FIG. 10, redundancy is established for a plurality of wiring in the logic platter 160 and the supply of power to the hard disk power supply controller 127 is provided with plural redundancy. Thus, in FIG. 10, not only is the AC switching power supply 125 made redundant, but also, by feeding power from the DC switching power supply 128, plural power supply redundancy is implemented by supplying power from both the AC switching power supply 125 and the DC switching power supply 128. In this case, even if a fault occurs in the wiring in the logic platter 160 for supplying power from the AC switching power supply 125, power can be fed from the DC switching power supply 128. Furthermore, the storage apparatus 100 can be operated by the DC switching power supply 128 by shutting off the AC switching power supply 125, thereby improving the reliability of the whole system.

In addition, SVP information including fault generation information is sent back to the SVP 130 from the hard disk power supply controller 127 and the supply of power to the wiring in the logic platter 160 where the fault occurred is shut off under the control of the SVP 130. As a result, if a fault occurs, the point of the fault can be rapidly detected and the fault point can be easily isolated. Furthermore, since the power consumption of the whole apparatus can be lowered by the supply of DC power, the power consumption of the overall system can be reduced.

As described earlier, according to this embodiment, by providing the wiring of the AC power supply system and DC power supply system in duplicate on the logic platter 160, even if migration such as data migration is carried out, the migration can be executed without stopping the system. Moreover, since the output voltage of the power supply has the same voltage and has the same path, an apparatus in which the AC to DC power supply and the DC to DC power supply are interchangeable can be realized. Furthermore, a change from the AC to DC power supply system to the DC to DC power supply system can be executed while the system is operating.

Furthermore, if the storage apparatus 100 is changed from the AC power supply system to the DC power supply system, the same work as an AC to DC power supply switch is realized while the apparatus is operating and migration from the AC power supply system to a DC power supply system can be easily effected by performing a switch from the AC to DC power supply to the DC to DC power supply. In addition, in this embodiment, since the power supply system corresponding to a low voltage and the power supply system corresponding to a high voltage are interchangeable, the migration from a low voltage to a high voltage can be easily executed. Accordingly, since a large current capacity is required at a low voltage (DC −48V, for example), if a plurality of feed cables are introduced from above and maintainability is difficult, maintainability can be improved by migrating to a high voltage (DC 380V, for example) to reduce the feed cables from above.

Moreover, in this embodiment, the wiring in the logic platter 160 is multiplexed and, by providing a switching power supply (SWPS) in which the AC power supply and DC power supply are interchangeable, power supplies which are compatible with both a high voltage (DC 380V, for example) and a low voltage (DC −48V, for example) is supported, and the switch from the AC power supply system to the DC power supply system can be made simply by exchanging the power supply alone. Moreover, by taking a high voltage (DC380V, for example) feed as the power distribution device, the feed cables can be reduced and the maintenance work on the system overall can be simplified.

Furthermore, in cases where the AC to DC power supply and DC to DC power supply has a common output voltage, the voltage is converted in the power supply unit and, by exchanging the AC to DC power supply for a DC to DC power supply, the same maintainability can be secured between the AC power supply system and the DC power supply system. Moreover, by using a DC to DC power supply, the PFC 115 provided in the AC to DC power supply is unnecessary, whereby the number of component parts of the power supply can be reduced and the rate of failure can be lowered.

Moreover, in this embodiment, the supply of power to each of the parts of the disk controller module 110 and disk unit module 120 can be controlled by the SVP 130. For example, based on the information on the supply of power which is configured by the SVP 130, power distribution is performed, i.e. AC power is supplied to any of the disk drives 16 or DC power is supplied to any of the disk drives 16. Furthermore, the specifications of the power supply of the storage apparatus 100 may also be configured by the SVP 130. The processing to configure the power supply information by the SVP 130 will be described hereinbelow. As described earlier, the SVP 130 receives instructions which are input by the operator via the management terminal 300 from an SVP input receiver unit 131 (not shown). Furthermore, the SVP input receiver unit 131 reports the received instruction to an SVP control program 132 (not shown) for changing the configuration and the like of the storage apparatus 100.

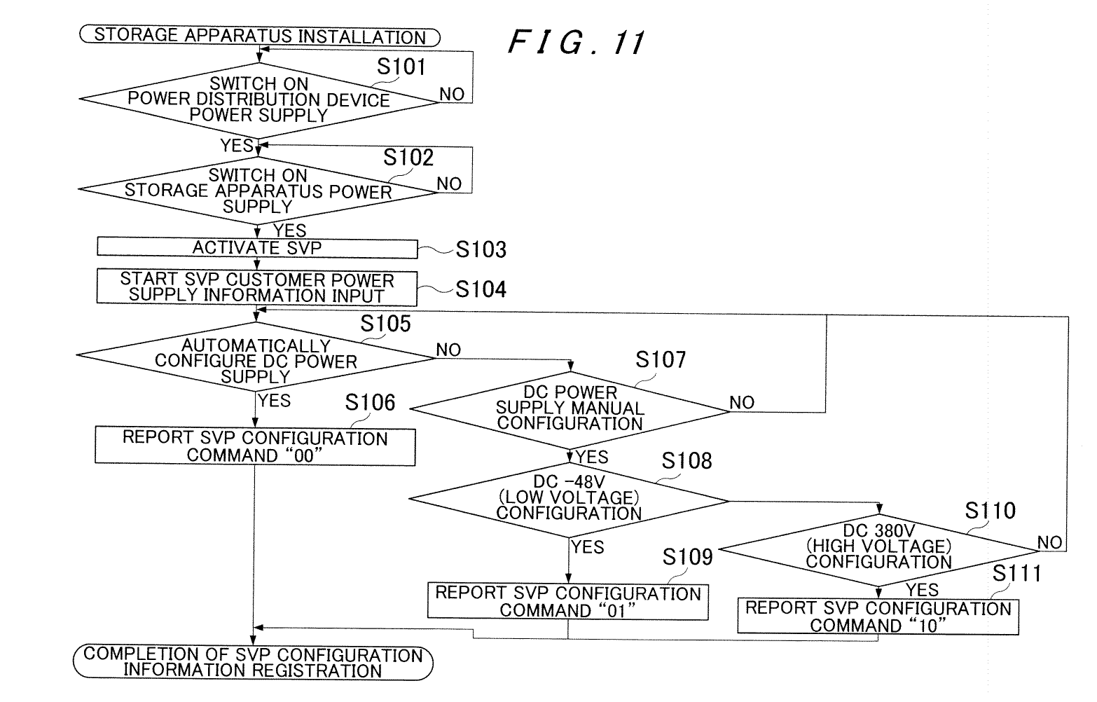

Processing to configure the DC power supply performed by the SVP 130 will first be described. The configuration processing of the DC power supply is processing for configuring the method by which DC power is to be fed from the power supply device of the user to the switching power supply of the storage apparatus 100. As shown in FIG. 11, when the storage apparatus 100 is installed, the power supply of the power distribution device is first turned on (S101). Here, the power distribution device is the DC switchboard 146 shown in FIG. 6. The power supply of the storage apparatus 100 is then turned on (S102). The SVP 130 is then activated (S103).

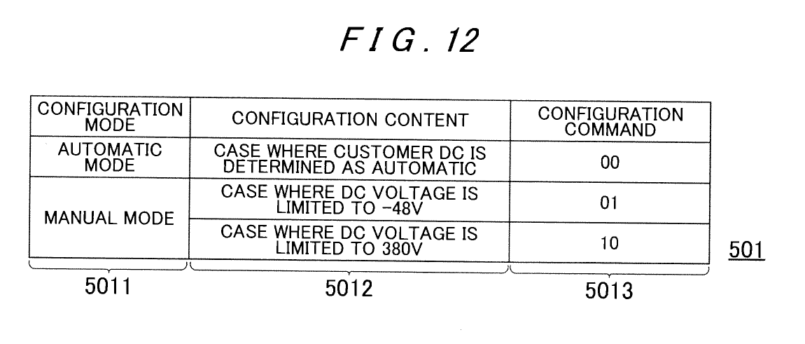

Then, after the SVP 130 is activated, the inputting, by the operator, of power supply information of the customer is stared (S104). In step S104, the SVP input receiver unit 131 receives an input of customer power supply information which is input by the management terminal 300. For example, the SVP control program 132 configures the corresponding command as a result of an automatic mode configuration or manual mode configuration being selected in response to an operator input. Here, configuration content 501 of the power supply specification configured in response to an operator input will be described with reference to FIG. 12. As shown in FIG. 12, the configuration content 501 which is configured in response to an operator input is a configuration mode 5011, configuration content 5012, and a configuration command 5013, and the like.

Either automatic mode or manual mode is first configured as the configuration mode 5011. The automatic mode is a mode for automatically determining the customer DC and the configuration command “00” is configured by the SVP control program 132. In addition, manual mode is a mode which is limited to a predetermined DC voltage, and either a case where the DC voltage is limited to −48V or a case where the DC voltage is limited to 380V is selected, for example. In a case where automatic mode, in which the DC voltage is limited to −48V, is selected by the operator input, the SVP control program 132 configures “01” as the configuration mode. Furthermore, if manual mode, in which the DC voltage is limited to 380V, is selected by the operator input, the SVP control program 132 configures “10” as the configuration mode.

Returning now to FIG. 11, the SVP input receiver unit 131 determines whether the customer power supply information input by the operator in step S104 has been configured as the automatic mode of the DC power supply (S105). If it is determined in step S105 that this information has been configured as the automatic mode, the SVP input receiver unit 131 reports the configuration command “00” to the SVP control program 132 (S106).

If it is determined in step S105 that this information has not been configured as the automatic mode, the SVP input receiver unit 131 determines whether the customer power supply information input by the operator has been configured as the manual mode of the DC power supply (S107). In addition, the SVP input receiver unit 131 determines whether the customer power supply information input by the operator has been configured as the manual mode in which the DC voltage is configured as −48V (S108).

If it is determined in step S107 that the customer power supply information has not been configured as the manual mode of the DC power supply, the SVP input receiver unit 131 returns to the processing of step S105 and subsequent steps.

If it is determined in step S108 that the customer power supply information input by the operator is automatic mode in which the DC voltage has been configured as −48V (low voltage), the SVP input receiver unit 131 reports the configuration command “01” to the SVP control program 132 (S109).

Meanwhile, if it is determined in step S108 that the customer power supply information that is input by the operator is not manual mode in which the DC voltage is configured as −48V (low voltage), the SVP input receiver unit 131 determines whether the customer power supply information is manual mode in which the DC voltage is configured as 380V (high voltage) (S110). If it is determined in step S110 that the customer power supply information is manual mode in which the DC voltage is configured as 380V, the SVP input receiver unit 131 reports the configuration command “10” to the SVP control program 132 (S111).

If it is determined in step S110 that the customer power supply information is not manual mode in which the DC voltage is configured as 380V, the SVP input receiver unit 131 returns to the processing of step S105 and subsequent steps. As a result of the foregoing processing, the registration of the DC power supply configuration information by the SVP 130 is complete.

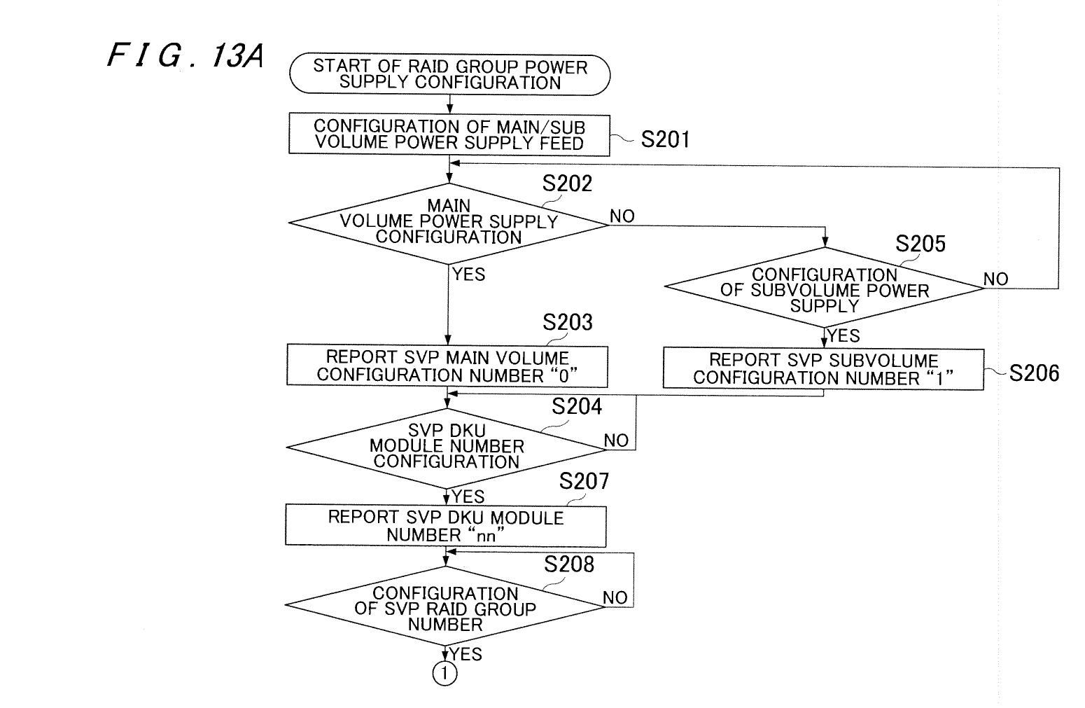

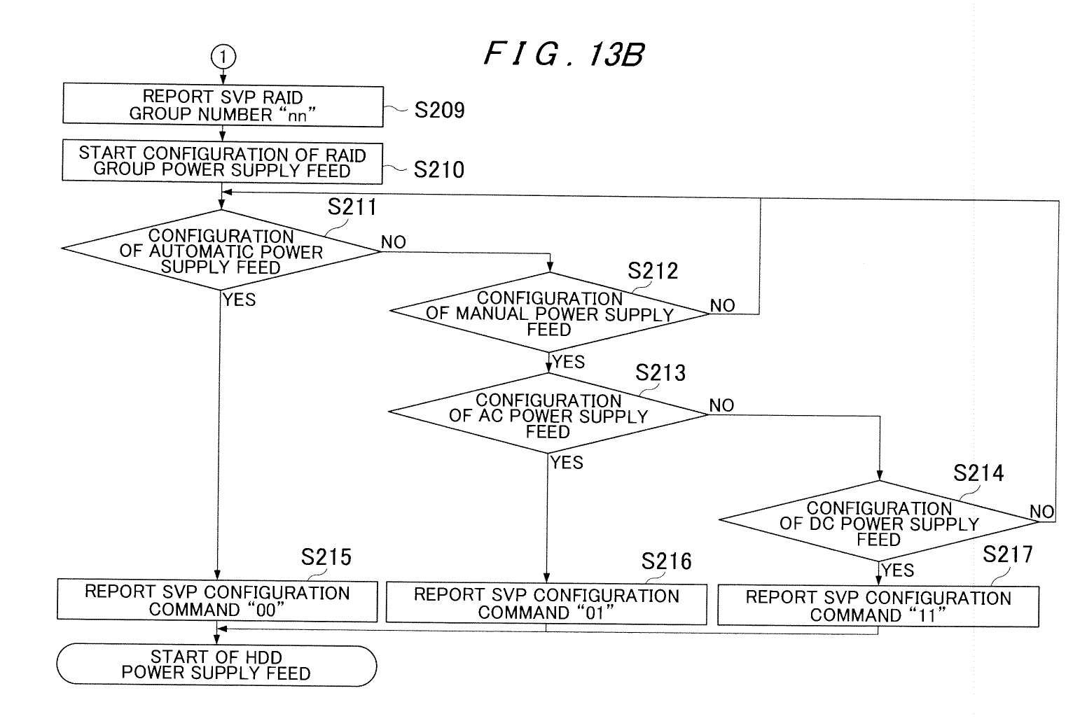

Power distribution configuration processing for distributing the power supplied to each disk drive 122 will be described next with reference to FIGS. 13A and 13B. For example, if the apparatus is requested by the customer to operate in low consumption power mode, the apparatus is operated by distributing power to each of the disk drives 122. For example, if power is fed from the AC power supply system or DC power supply system to the storage apparatus 100, when a fault occurs with the AC power supply system, a switch to power being fed from the DC power supply system is typical. However, in a case where the main volume is connected to the AC power supply system and the subvolume is connected to the DC power supply system in response to a low-consumption power mode request from the customer, if a fault occurs with the AC power supply system or the DC power supply system, a whole system fault arises. Therefore, after connecting the main volume to the AC power supply system and connecting the subvolume to the DC power supply system when the low-consumption power mode is configured, it is considered possible to avoid the generation of a whole system fault by configuring a RAID group as RAID51 (3D+1P, 3D+1P). However, in this case, there is a problem in that, although power consumption can be curbed, there are costs incurred in configuring the RAID group as RAID51.

In order to avoid the foregoing problem, as shown in FIG. 10, the power feed to the storage apparatus 100 is configured in a plurality and, by providing a multiplexed power supply input, the system can be prevented from shutting down while also curbing the power consumption. For example, by configuring the RAID group as a RAID5 and also feeding power from the DC power supply system, the power consumption can be suppressed to a greater degree than in a case where a connection is only made to the AC power supply system. A specific example of power supply distribution configuration processing for distributing power supplied to each disk drive 122 will be described hereinbelow.

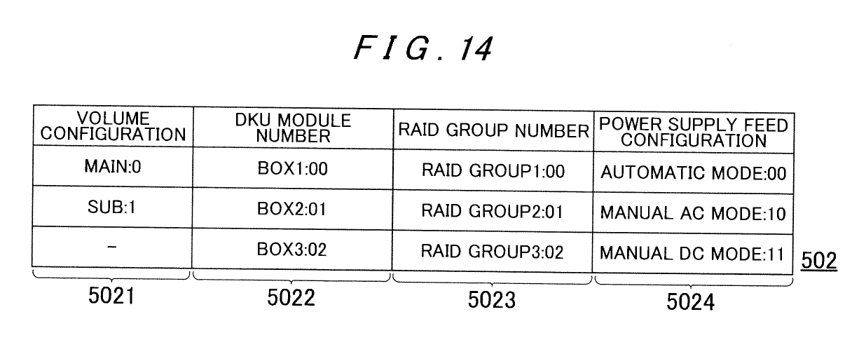

As shown in FIG. 13A, the power configuration is started for each RAID group. The power feed to the main volume or subvolume is first configured according to an operator input (S201). Here, configuration content 502 for the power feed to each volume configured in response to an operator input will be described with reference to FIG. 14. As shown in FIG. 14, the configuration content 502 for the power feed to each volume which is configured in response to an operator input is volume configuration 5021, a DKU module number 5022, a RAID group number 5023, and a power feed configuration 5024, and the like.

A main volume (0) or subvolume (1) is first configured as the volume configuration 5021. Furthermore, the disk unit (DKU) module number and the RAID group number are also configured. In addition, the power feed method 5023 is configured for the disk drives 122 which are designated by the volume numbers, disk unit module numbers and RAID group numbers. The power feed method can be exemplified by the automatic mode “00”, manual AC mode “10”, or manual DC mode “11”, for example. If, for example, RAID group 1 in a disk unit module Box1 of the main volume is configured with a DC feed, a configuration command “0000011” is then configured.

Returning to FIG. 13A, the SVP input receiver unit 131 determines whether the configuration information input by the operator in step S201 is a configuration for the main volume (S202). If it is determined in step S202 that the configuration information is a configuration for the main volume, the SVP input receiver unit 131 reports “0”, which is the main volume configuration number, to the SVP control program 132 (S203).

If, on the other hand, it is determined in step S201 that the configuration information which is input by the operator is not a configuration for the main volume, the SVP input receiver unit 131 determines whether the configuration information is a configuration for the subvolume (S205). If it is determined in step S205 that the configuration information is a configuration for the subvolume, the SVP input receiver unit 131 reports “1”, which is a subvolume configuration number, to the SVP control program 132 (S206). If, on the other hand, it is determined in step S205 that the configuration information is not a configuration for the subvolume, the SVP input receiver unit 131 executes the processing of step S202 and subsequent steps.

The SVP input receiver unit 131 then determines whether the configuration information input by the operator is configuration information for a disk unit module number (S204). If it is determined in step S204 that the configuration information which is input by the operator is configuration for a disk unit module number, the SVP input receiver unit 131 reports a disk unit module number “nn” to the SVP control program 132 (S207). If, on the other hand, it is determined in step S204 that the configuration information input by the operator is not configuration information of a disk unit module number, the SVP input receiver unit 131 repeats the processing of step S204.

The SVP input receiver unit 131 subsequently determines whether the configuration information input by the operator is configuration information for a RAID group number (S208). If it is determined in step S208 that the configuration information input by the operator is configuration information for a RAID group number, the SVP input receiver unit 131 reports the RAID group number “nn” to the SVP control program 132 (S209).

The SVP input receiver unit 131 then starts a power feed configuration for the RAID group (S210). The SVP input receiver unit 131 first determines whether the configuration information input by the operator is a mode in which the power feed is automatically configured (S211). If it is determined in step S211 that the configuration information thus input is a mode in which the power feed is automatically configured, the SVP input receiver unit 131 reports the configuration command “00” indicating automatic mode to the SVP control program 132 (S215).

Meanwhile, if it is determined in step S211 that the configuration information thus input is not a mode in which the power feed is automatically configured, the SVP input receiver unit 131 determines whether the configuration information is a mode in which the power feed is manually configured (S212). If it is determined in step S212 that the configuration information is a mode in which the power feed is manually configured, the SVP input receiver unit 131 determines whether the configuration information is a mode in which the AC power feed is configured (S213). If, on the other hand, it is determined in step S212 that the configuration information is not a mode in which the power feed is manually configured, the SVP input receiver unit 131 executes the processing of steps S211 and subsequent steps.

If it is determined in step S213 that the configuration information is a mode in which the AC power feed is configured, the SVP input receiver unit 131 reports a configuration command “01” indicating the manual AC mode to the SVP control program 132 (S216). If, on the other hand, it is determined in step S213 that the configuration information is a mode in which the AC power feed is configured, the SVP input receiver unit 131 determines whether the configuration information is a mode in which the DC power feed is configured (S214).

If it is determined in step S214 that the configuration information is a mode in which the DC power feed is configured, the SVP input receiver unit 131 reports a configuration command “11” indicating a manual DC mode to the SVP control program 132 (S217). If, on the other hand, it is determined in step S214 that the configuration information is not a mode in which the DC power feed is configured, the SVP input receiver unit 131 executes the processing of step S211 and subsequent steps. The RAID group power supply configuration processing by the SVP 130 is then complete as a result of the foregoing processing, whereupon the power feed to the disk drive (HDD) 210 (not shown) is started.

Power supply processing in which, in the event of a fault with the disk drive 210, the disk drive 210 with the fault is restored by collection copy processing, will be described next. Here, collection copy processing is processing whereby, if a fault occurs with the disk drive 210, data that is stored in the disk drive 210 is recovered and copied to a spare disk drive 210. For example, if the RAID group is RAIDS (3D+1P) and one fault in the disk drive 210 is generated, power consumption can be curbed by changing the power feed method from an AC power feed to a DC power feed.

When a fault with the disk drive 210 occurs, the determination of whether or not to make the switch from the AC power feed to the DC power feed is made by the SVP control program 132. The SVP control program 132 may determine the power feed method based on a pre-configured power feed information, or may calculate the power consumption for when power is fed from an AC power feed and when power is fed from a DC power feed, and may determine the power feed method in response to the calculation result. The processing, by the SVP control program 132, to calculate the power consumption will be described subsequently in detail.

The SVP control program 132 pre-configures the power feed method at the time of collection copy processing. For example, the SVP control program 132 configures the configuration command according to whether a DC switching power supply (DC SWPS) 128 is installed in the disk unit module 120.

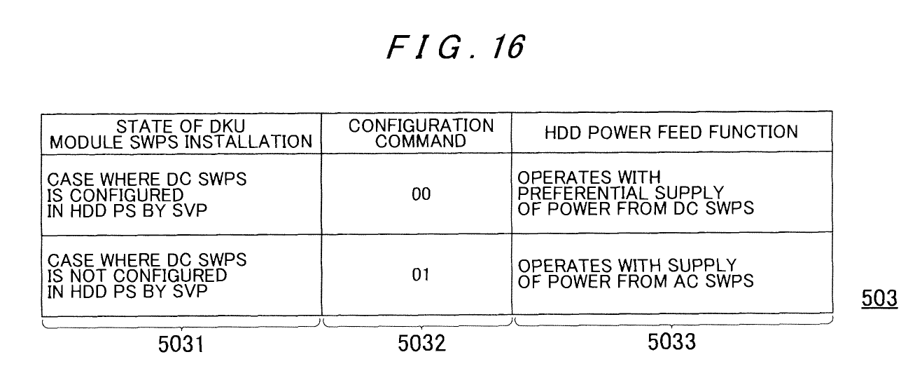

Here, the configuration content 503 of the power feed at the time of collection copy processing which is configured by the SVP control program 132 will be described with reference to FIG. 16. The configuration content 503 of the power feed at the time of collection copy processing is the disk unit (DKU) module switching power supply (SWPS) installation state 5031, the configuration command 5032, and the HDD power feed function 5033, and the like.

As shown in FIG. 16, if, for example, it is recognized by the SVP 130 that the DC switching power supply 128 has been configured in the hard disk power supply controller (HDD PS) 127, the SVP control program 132 configures the configuration command 5032 as “00”. If, on the other hand, it is not recognized by the SVP 130 that the DC switching power supply 128 has been configured in the hard disk power supply controller (HDD PS) 127, the SVP control program 132 configures the configuration command 5032 as “01”.

Furthermore, if the configuration command 5032 is configured as “00”, at the time of collection copy processing, the disk drive 210 is operated by supplying power preferentially from the DC switching power supply (DC SWPS). For example, if power is supplied from the AC switching power supply 125 prior to the fault of the disk drive 210, the power feed is switched, after the fault with the disk drive 210 is generated, to the power feed from the DC switching power supply 128. Moreover, if the configuration command 5032 is configured as “01”, power is supplied from the AC switching power supply 125 without switching to the power feed from the DC switching power supply 128.

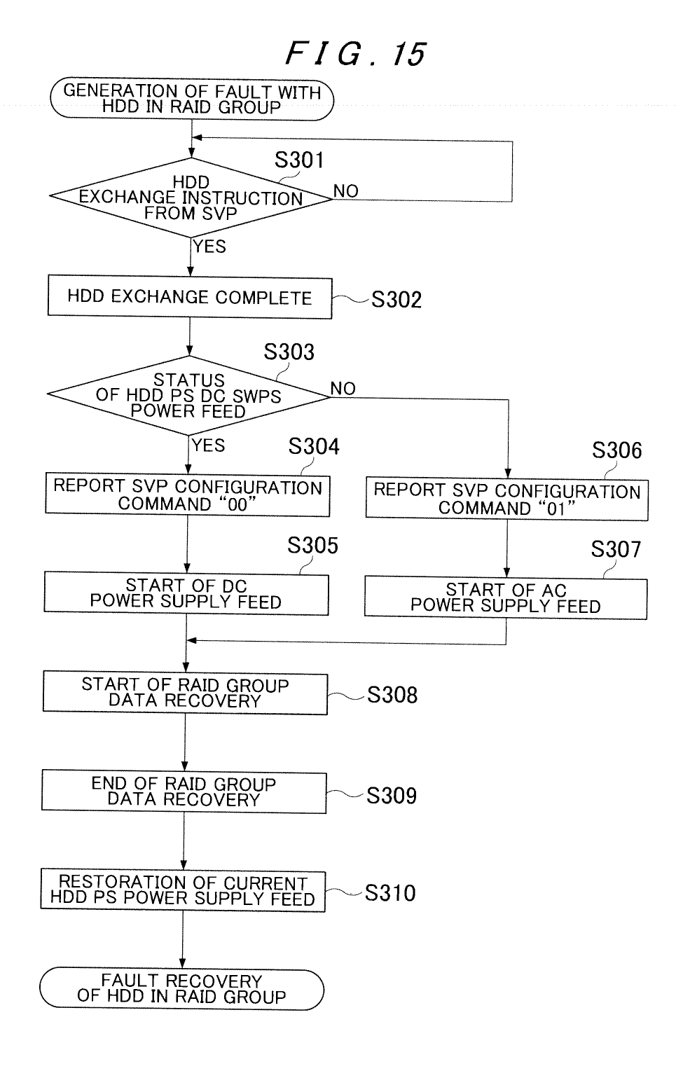

As shown in FIG. 15, when a fault arises with an HDD (disk drive 210) in the RAID group 121, an HDD exchange instruction from the SVP 130 is output to the operator (S301). The operator exchanges the HDD based on the HDD exchange instruction of step S301 and the SVP control program 132 detects that the exchange is complete (S302).

The hard disk power supply controller (HDD PS) 127 then determines whether there is a DC switching power supply 128 installed and whether DC power can be supplied (S303).

If it is determined in step S303 that a DC switching power supply 128 is installed and DC power can be fed, the hard disk power supply controller (HDD PS) 127 reports the SVP configuration command “00” to the SVP control program 132 (S304). The SVP control program 132 configures the configuration command (00) reported in step S304 as the power-feed configuration content at the time of collection copy processing and starts the feeding of DC power to the disk drive 210 (S305).

If, on the other hand, it is determined in step S303 that the DC switching power supply 128 has not been installed and that DC power cannot be fed, the hard disk power supply controller (HDD PS) 127 reports the SVP configuration command “01” to the SVP control program 132 (S306). The SVP control program 132 configures the configuration command (01) reported in step S306 as the power-feed configuration content at the time of collection copy processing and starts the AC power feed to the disk drive 210 (S307).

When the power feed to the disk drive 210 is started in step S305 or S307, the recovery of data of the RAID group 121 is started under the control of the disk adapter 116 and the switch 124 (S308), and then the recovery of data of the RAID group 121 ends (S309).

Thereafter, when the current power feed method is restored by the hard disk power supply controller (HDD PS) 127 (S310), the HDD fault in the RAID group 121 is repaired and the collection copy processing ends.

The processing by the SVP control program 132 to calculate power consumption will be described next. As mentioned earlier, the SVP control program 132 determines the power feed method depending on the power consumption calculation result. For example, a surveillance monitor for inspecting the voltage/current in the AC switching power supply 125 and the DC switching power supply 128 is installed and the power consumption is calculated based on the voltage and current detected by the surveillance monitor. In this embodiment, it is possible to calculate not only the voltage and current detected by the surveillance monitor but also the power consumption based on apparatus configuration information and a current ratio distribution table or similar.

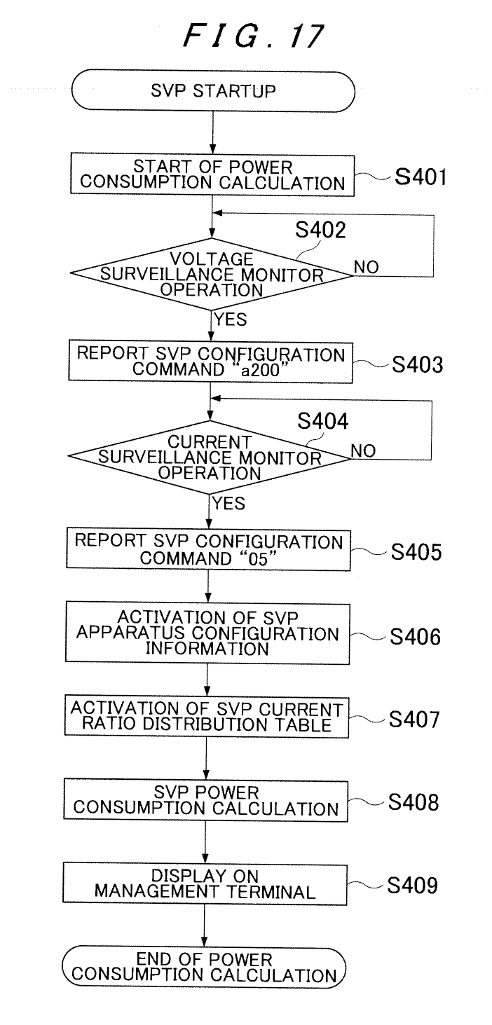

As shown in FIG. 17, when the SVP 130 is activated, the processing by the SVP control program 132 to calculate the power consumption is started (S401).

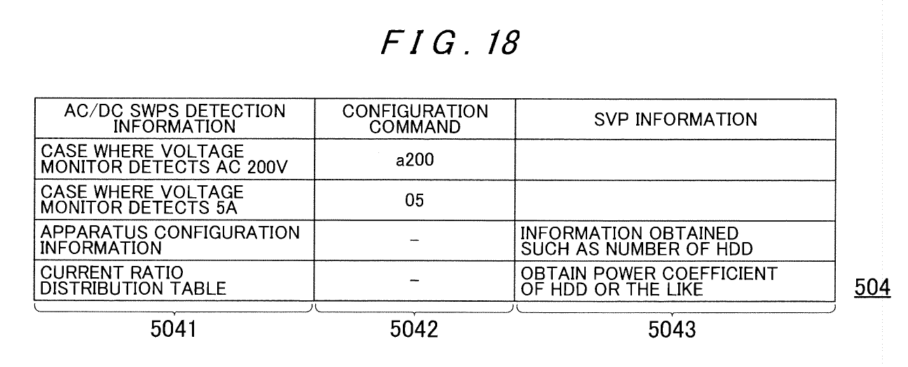

Here, the reference information 504 at the time of power consumption calculation processing by the SVP control program 132 will be described. As shown in FIG. 18, the reference information 504 at the time of power consumption calculation processing is AC/DC switching power supply (SWPS) detection information 5041, configuration command 5042, and SVP information 5043. The AC/DC switching power supply detection information 5041, and the like. The AC/DC switching power supply detection information 5041 is content of the detection information detected by the surveillance monitor in the AC switching power supply 125 or DC switching power supply 128.

For example, if the AC 200V is detected by the voltage monitor in the AC switching power supply 125, “a200” is reported by the voltage monitor to the SVP130 as the configuration command. Furthermore, if 5A is detected by the current monitor in the AC switching power supply 125, “05” is reported to the SVP 130 as a configuration command. The SVP control program 132 collects various information in the storage apparatus 100 and obtains information such as apparatus configuration information and current ratio distribution table. The apparatus configuration information is, for example, information such as the number of disk drives (HDD) 210. Further, the current ratio distribution table information is, for example, power coefficient information for the disk drive (HDD) 210.

Returning to FIG. 17, the SVP control program 132 determines whether or not the voltage surveillance monitor is operating (S402).

If it is determined in step S402 that the voltage surveillance monitor is operating, “a200” which indicates that the voltage from the voltage monitor in the AC switching power supply 125 is AC 200V is reported to the SVP 130 (S403). If, on the other hand, it is determined in step S402 that the voltage surveillance monitor is not operating, [the SVP control program 132] repeats the processing of step S402.

The SVP control program 132 subsequently determines whether or not the current surveillance monitor is operating (S404).

If it is determined in step S404 that the current monitoring is operating, “05”, which indicates that the current from the current monitor in the AC switching power supply 125 is 5A, is reported to the SVP 130 (S405). If, on the other hand, it is determined in step S404 that the current surveillance monitor is not operating, the SVP control program 132 repeats the processing of step S404.

The SVP 130 then activates the apparatus configuration information (S406) and activates the current ratio distribution table (S407). Based on the voltage value acquired in step S403, the current value acquired in step S405, the apparatus configuration information acquired in step S406, and the current ratio distribution table information acquired in step S407, the SVP control program 132 calculates the power consumption of the storage apparatus 100 (S408).

[The SVP control program 132] then displays the power consumption of the storage apparatus 100 calculated in step S408 on the display unit of the management terminal 300 (S409) and terminates the power consumption calculation processing.

(5) Effect of This Embodiment

As mentioned earlier, according to this embodiment, the power from the AC power supply system supplying AC power and the power from the DC power supply system supplying DC power can be made redundant and supplied to the storage apparatus, and, in response to the configuration input by the operator, the power from the AC power supply system can be supplied to any of the plurality of storage devices, while the power from the DC power supply system can be supplied to any of the storage devices. As a result, the power from two types of power supply, namely, an AC power supply and a DC power supply, can be supplied to the storage apparatus with redundancy, whereby high reliability and high availability can be realized for the storage apparatus.

(6) Other Embodiments

Although a case was described in the embodiment above in which the SVP 130 was adopted as the controller for controlling all the processing relating to the various functions of this embodiment, the present invention is not limited to such a case, rather, hardware and software which executes the processing of this controller may also be provided separately from the SVP 130. The same effect as that of the above embodiment can accordingly be obtained.

Furthermore, each of the steps of the processing of the storage apparatus 100 and so on of this specification need not necessarily be processed in chronological order in the sequence that appears in the flowchart. In other words, each of the steps in the processing of the storage apparatus 100 and so on may also be executed in parallel even with different processing.

Moreover, hardware such as the CPU, ROM, and RAM contained in the storage apparatus 100 and the like can also be created by a computer program which exhibits the same functions as each of the configurations of the foregoing storage apparatus 100 and the like. A storage medium which stores the computer program may also be provided.

### INDUSTRIAL APPLICABILITY

The present invention can be widely applied to storage apparatuses to which power from a DC power supply device can be supplied.

### REFERENCE SIGNS LIST

100, 100A, 100B Storage apparatus

111 Channel adapter

112 Connection controller

113 Cache memory

114 AC switching power supply

116 Disk adapter

117 DC switching power supply

120, 120A, 120B Disk unit module

122 Disk drive

123 Logical volume

124 Switch

125 AC switching power supply

127 Hard disk controller

128 DC switching power supply

130 SVP

140, 145 Power supply unit

141 AC switchboard

143 PDU power supply breaker

146 DC switchboard

160 Logic platter

300 Management terminal

1. A storage apparatus, comprising:
a power supply unit for supplying power to a plurality of storage devices; and
a power supply controller for controlling a method of supplying power from the power supply unit,
wherein the power supply unit makes redundant the power supplied from a first power supply device which supplies AC power and/or from a second power supply device which supplies DC power, and supplies this power to the plurality of storage devices, and
wherein, in response to a configuration input by the operator, the power supply controller supplies power from the first power supply device to one storage device among the plurality of storage devices and supplies power from the second power supply device to another storage device.

2. The storage apparatus according to claim 1,
wherein the plurality of storage devices are grouped into a plurality of groups each comprising a plurality of the storage devices, and
wherein the power supply controller supplies power from the first power supply device to one storage device group and supplies power from the second power supply device to another storage device group.

3. The storage apparatus according to claim 1,
wherein the plurality of storage devices configure a plurality of RAID groups, and
wherein, in response to the configuration input by the operator, the power supply controller supplies power from the first power supply device to one RAID group and supplies power from the second power supply device to another RAID group.

4. The storage apparatus according to claim 1,
wherein, if a fault occurs with the first power supply device, the power supply controller switches the supply of power of the power supply unit so that power is supplied from the second power supply device to the storage device which supplied power from the first power supply device.

5. The storage apparatus according to claim 1,
further comprising:
an I/O controller which is connected to a host apparatus which requests data writing, and
controls data I/O to and from the storage devices in response to a data write request from the host apparatus,
wherein the power supply unit makes redundant the power supplied from the first power supply device and the second power supply device and supplies this power to the I/O controller.

6. The storage apparatus according to claim 5,
wherein, if a fault occurs with the first power supply device, the power supply controller switches the supply of power of the power supply unit so that power is supplied from the second power supply device to the I/O controller that supplied power from the first power supply device.

7. The storage apparatus according to claim 1,
wherein the power supply controller controls the supply of power of the power supply unit so that, if a fault arises with one storage device among the plurality of storage devices, the supply of power to the one storage device is shut off.

8. The storage apparatus according to claim 1,
wherein the power supply unit uses a plurality of wiring to make redundant the supply of power from the first power supply device and/or the second power supply device, and
wherein, if a fault arises with one wiring, among the plurality of wiring, which supplies power from the first power supply device, the power supply controller uses another wiring which differs from the one wiring supplying power from the second power supply device to switch the supply of power of the power supply unit so that power is supplied to the plurality of storage devices.

9. The storage apparatus according to claim 1,
wherein the power supply controller determines the power supply specifications of the power supply unit according to the method of supplying power from the first power supply device and/or the second power supply device.

10. The storage apparatus according to claim 1,
wherein the power supply controller determines the power supply specifications of the power supply unit according to the configuration input by the operator.

11. The storage apparatus according to claim 1,
wherein, if a fault occurs with one storage device, among the plurality of storage devices, to which power is supplied from the first power supply device, the power supply controller supplies power from the second power supply device and exchanges the one storage device for another storage device.

12. The storage apparatus according to claim 1,
wherein the power supply unit detects the voltage and current of the power supplied from the first power supply device and/or the second power supply device, and
wherein the power supply controller calculates the power consumption amount from the information on the voltage and current detected by the power supply unit and information including the configuration information of the storage device and the power coefficient of the storage device.

13. The storage apparatus according to claim 1,
wherein the first power supply device and/or the second power supply device can be installed in the storage apparatus,
wherein the power supply unit identifies the power supplied from the first power supply device and/or the second power supply device, and
wherein, at the time of a fault with a power supply which has an identification signal supplied from the first power supply device and/or the second power supply device, the power supply unit specifies the type of the faulty power supply, and transmits information including notification to the effect that the power supply of the first power supply device or the second power supply device is to be exchanged to the management terminal connected to the storage apparatus.

14. The storage apparatus according to claim 1,
wherein the power supply unit minimizes the power supplied by the second power supply device, and provides another expansion mechanism for the minimized power to make same compatible with the first power supply device.

15. A power supply method of a storage apparatus comprising a power supply unit for supplying power to a plurality of storage devices and a power supply controller for controlling a method of supplying power from the power supply unit, the power supply method comprising:
a first step in which the power supply unit makes redundant the power supplied from the first power supply device which supplies AC power and/or the second power supply device which supplies DC power and supplies this power to the plurality of storage devices; and
a second step in which the power supply controller supplies power from the first power supply device to one storage device among the plurality of storage devices in response to a configuration input by the operator and supplies power from the second power supply device to another storage device.
